(19) United States
(12) Patent Application Publication
(10) Pub. No.: US 2021/0082069 A1
(43) Pub. Date: Mar. 18, 2021

(54) Patent Co-op

(71) Applicant: Charles G. Bagg, Fitchburg, MA (US)

(72) Inventor: Charles G. Bagg, Fitchburg, MA (US)

(21) Appl. No.: 16/574,223

(22) Filed: Sep. 18, 2019

(51) Int. Cl. G06Q 50/18; G06Q 30/02

(52) U.S. Cl. CPC G06Q 50/184; G06Q 30/0201

(57) ABSTRACT

The present invention is a method of doing business that involves creating a novel business entity to function as an “Inventors Cooperative Alliance” (hereinafter referred to as an ICA). The primary function of the ICA is to dramatically lower the cost and risk of an individual inventor getting and marketing a patent by creating a sub-entity called a “Patent Co-op” which can be duplicated locally, or replicated thousands of times nation-wide by selling franchises.

### CROSS REFERENCE TO RELATED PATENTS

Not Applicable

### STATEMENT OF FEDERALLY SPONSORED RESEARCH

Not Applicable

### PARTIES TO A JOINT RESEARCH AGREEMENT

Not Applicable

### REFERENCE TO A SEQUENCE LISTING, TABLE, OR COMPUTER PROGRAM

Not Applicable

### BACKGROUND OF THE INVENTION

Many low or middle income people may have great ideas for wonderful new inventions, but getting a patent is prohibitively expensive for these people. Even a fairly simple patent can easily cost $10,000 to $15,000 or more. And there is no guarantee that the inventor will ever get the invention to market or make money from it. Many individual inventors just can't come up with that much money, much less afford to gamble it on a long shot.

If an inventor doesn't have a patent, or at least a patent pending, and tries to sell his or her invention to an existing manufacturer, most companies won't even talk to them. To make matters worse, there are many “invention development” companies that prey on unsuspecting inventors, promising to get their ideas to market—for a price. Even if the idea is already patented, completely worthless, totally unfeasible, or otherwise unmarketable, the development company will keep making promises and taking the inventors money. They won't try to steal the invention because that would be too much like work.

### BRIEF SUMMARY OF THE INVENTION

The present invention is a method of doing business that involves organizing a novel business entity to function as an “Inventors Cooperative Alliance” (hereinafter referred to as an ICA). The primary function of the ICA is to dramatically lower the cost and risk of patenting and marketing an invention for individual inventors by organizing a sub-entity called a “Patent Co-op” which can be duplicated locally, or replicated thousands of times nation-wide by selling franchises.

The organizer, typically a patent attorney or patent agent, establishes the ICA which then organizes multiple Patent Co-ops. The Co-op recruits a group of independent inventors, perhaps along with some support personnel, and provides a legal framework whereby the inventors can enter into a cooperative agreement to share their invention ideas with the group, discuss the pros and cons of each idea, investigate the feasibility, patentability, and market potential of each, select the most promising contender or contenders, pool their funds to pay for one or more patent applications, and share the proceeds if an invention is successful.

### BRIEF DESCRIPTION OF THE DRAWINGS

FIG. 1 is an organizational chart showing how the Patent Co-ops would be created, developed, funded, operated, and expanded.

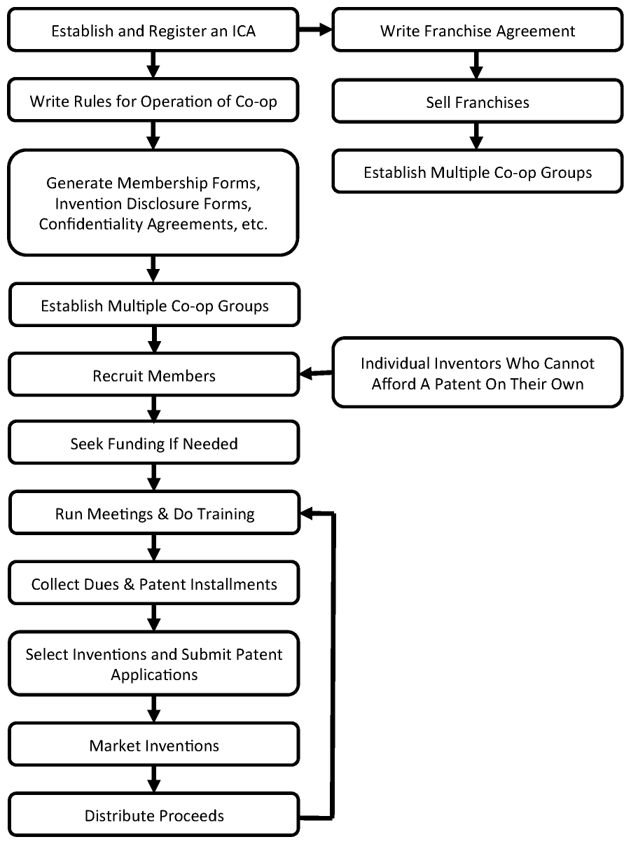

### DETAILED DESCRIPTION

The initial organizer officially establishes the ICA, registers it with the applicable authorities, and develops the rules and regulations that will govern the business. The organizer will also generate the necessary forms, agreements, and other official documents needed to operate the business, and will recruit people to become members of the co-op. The organizer also serves as a guide and coach, and may train the members to do their own patent searches, do market studies, and research manufacturing methods, etc. The organizer may bring in outside experts to help in these matters, or may recruit some non-inventor members to provide such expertise. Motivational talks and sales training could also be offered. The organizer may seek additional funding if needed, from either a group member, or from an outside investor. If just one co-op has a major success, these co-ops may be seen as an extremely attractive investment opportunity by potential investors.

Co-op members can be recruited from any segment of the population, but technical high schools and colleges might be the most promising, as the students will already have some rudimentary knowledge of what might be technically feasible. But social or religious organizations could also be contacted, along groups of employees who work together.

It should be understood that the organizer may designate assistants or subordinates to perform various tasks such that any reference to the organizer within this document may alternately be construed to apply to a designated assistant or subordinate.

To insure that every co-op organized under this business model is fair, ethical, responsible, trustworthy, and competently run, the ICA headquarters will establish the company name and brand, register any trademarks, copyright any logos, official documents, or other media, generate the co-op agreements, establish the rules for additional organizers, sell franchises to other organizers, and train them as needed.

Each member of the coop shall sign a confidentiality agreement promising not to divulge proprietary information outside the group. Each inventor shall agree to submit at least one invention to the group describing it in enough detail to enable a fair evaluation and comparison to the other submitted inventions.

The organizer will schedule regular meetings of the members and will help them to understand each invention fully, help them to see the pros and cons of each idea, help them to understand how long it might take and how much it might cost to develop each idea, and how much income might be derived from it.

In most cases, the preferred way to market a new independent invention for the quickest return is to apply for a patent and then try to sell the patent rights to an existing manufacturer that is already marketing a line of similar products. Patent rights can typically be sold for a small royalty of about 5%, with an initial up-front advance on those royalties. To allow the coop to quickly move on to the next project, it might be desirable to trade off a smaller long term royalty for a larger up-front payment, or even a single lump sum agreement. Follow-on inventions could be negotiated for longer term royalties.

However, there are certainly other marketing alternatives. If the product can be manufactured in small quantities quickly and cheaply, perhaps by a turn-key contract manufacturer, it could be sold by direct marketing. Orders could be placed and paid for by customers, and the products could then be produced and drop-shipped to the customers by the manufacturer.

Another approach would be to sell the rights to a mass marketing company that would arrange for the manufacturing, run an advertising blitz, and sell the products directly as is often done with many “As Seen On TV” products.

Various other methods of manufacturing and distribution may be feasible, depending on the product. If the invention is a service rather than a product, still other arrangements may present themselves.

The organizer may receive a small payment in the form of membership dues, but most of the payment would be from a share of the profit, the same way as the regular members. Profit sharing will serve as a strong incentive for the organizer to do everything in his or her power to make the venture a financial success.

I claim a method of doing business comprising:

1. The process of establishing an “Inventors Cooperative Alliance” (Abbreviated: ICA), said ICA initiating the establishment of at least one “Patent Co-op” whereby a group of inventors who cannot afford patents as individuals may become members of said Patent Co-op to pool their inventions, funds, and other resources in order to patent and market at least one of their inventions for the mutual benefit of all the members.

2. The process of establishing and operating an ICA as in claim 1 which includes: legally forming and officially registering said ICA for the primary purpose of establishing Patent Co-ops; writing a set of rules and regulations to govern said Patent Co-ops; generating a set of forms, agreements, and other legal documents needed for the operation of said Patent Co-ops; recruiting inventors and other interested parties to join said Patent Co-ops; seeking additional funding and technical expertise if needed; running meetings and providing member guidance and training as needed; collecting funds from the members to pay for the preparation and filing of the patents; preparing and filing one or more patents on behalf of the Co-op; helping the members to market the invention as soon as the patent is pending; distributing the proceeds to the members if the patent rights are successfully marketed; distributing the proceeds to the members if the rights are retained but the invention itself is successfully marketed.

3. The process of establishing and operating an ICA as in claim 1 which further includes writing a franchise agreement and attempting to sell franchises to create additional Patent Co-op units.

4. The establishment of an “Inventors Cooperative Alliance” (Abbreviated: ICA), said ICA initiating the establishment of at least one “Patent Co-op” whereby a group of inventors who cannot afford patents as individuals may become members of said Patent Co-op to pool their inventions, funds, and other resources in order to patent and market at least one of their inventions for the mutual benefit of all the members.

5. The establishment and operation of an ICA as in claim 4 which includes: legally forming and officially registering said ICA for the primary purpose of establishing Patent Co-ops; writing a set of rules and regulations to govern said Patent Co-ops; generating a set of forms, agreements, and other legal documents needed for the operation of said Patent Co-ops; recruiting inventors and other interested parties to join said Patent Co-ops; seeking additional funding and technical expertise if needed; running meetings and providing member guidance and training as needed; collecting funds from the members to pay for the preparation and filing of the patents; preparing and filing one or more patents on behalf of the Co-op; helping the members to market the invention as soon as the patent is pending; distributing the proceeds to the members if the patent rights are successfully marketed; distributing the proceeds to the members if the rights are retained but the invention itself is successfully marketed.

6. The establishment and operation of an ICA as in claim 4 which further includes writing a franchise agreement and attempting to sell franchises to create additional Patent Co-op units.
